(19) United States
(12) Patent Application Publication
(10) Pub. No.: US 2023/0302842 A1
(43) Pub. Date: Sep. 28, 2023

(54) FILE FOLDER ASSEMBLY AND ORGANIZER WRAP

(71) Applicant: Karen Barreca, East Amherst, NY (US)

(72) Inventor: Karen Barreca, East Amherst, NY (US)

(21) Appl. No.: 18/188,032

(22) Filed: Mar. 22, 2023

Related U.S. Application Data
(60) Provisional application No. 63/322,430, filed on Mar. 22, 2022.

(51) Int. Cl. B42F 23/00; B65B 5/06

(52) U.S. Cl. CPC B42F 23/00; B65B 5/06; B42P 2241/02

(57) ABSTRACT

A folder assembly having an elongated sheet for binding together documents transversely loaded therein is provided. The elongated sheet may provide two sets of expandable fold lines for folding and wrapping the elongated sheet around the midsection of a stack of documents so that the opposing ends of the documents are visible with the folder assembly fully engaged with the documents. Opposing surfaces of the elongated sheet may provide detachable fasteners for moving the folded elongated sheet to a fastened condition, securely binding the documents. A tab may be provided at one end of the elongated sheet for labeling purposes.

### CROSS-REFERENCE TO RELATED APPLICATION

This application claims the benefit of priority of U.S. provisional application no. 63/322,430, filed 22-MAR-2022, the contents of which are herein incorporated by reference.

### BACKGROUND OF THE INVENTION

The present invention relates to file folder assemblies and mail organizers and more particularly, to a fold and tuck file folder assembly, that secures mail in a convenient organizer wrap.

There is limited storage space in offices and homes. People are bombarded with mail cluttering desks and can’t easily contain the disorganization. Other folders are large, usually 8.5” × 11” and take up space, and so mail that is stored in them can easily fall out. Also disadvantageous, accordion file folders are bulky and hide the contents. In short, existing file systems do not work well for mail because the typical folders do not bind the mail in secure, compact groups; rather, the mail is loosely placed in folders where it can fall out as well as requires the user to open the folder to have visibility of its contents.

A need exists for a fold and tuck file folder assembly, that secures mail in a convenient organizer wrap, thereby providing a method that improves the organization of mail by securing the folded mail in compact stacks with a top tab, making it easier to stack mail and visually inspect the contents of the folder assembly.

### SUMMARY OF THE INVENTION

The present invention provides an elongated planar sheet with two sets of fold lines spaced apart for folding the planar material around the girth of documents such as mail. The elongated planar sheet provides complements of one or more releasable fasteners on opposing surfaces so that in a folded condition the complements can selectively engage, forming a fastened engagement about the documents. One end of the elongated planar sheet may have a tab for labeling purposes.

As a result, with a simple fold with a tuck the file folder assembly of the present invention secures the documents/mail in small bundles by engaging the complementary detachable fasteners, removably binding the folded assembly to the documents. The bundles can then be labeled and stored in smaller boxes and drawers.

The file folders embodied in the present invention is self-assembled and wraps around the mail to form bounded bundles of semi-visible documents.

The present invention is better than other folders because it’s an easier way to organize mail and will save on space. The present invention is dimensioned and adapted to not completely cover the contents of the mail, affording user visibility of the mail/documents contained within the folder wrap.

In one aspect of the present invention, a file folder assembly include the following: an elongated planar sheet having a length defined by a first end and a second end, the elongated planar sheet having a first surface and a second surface opposing the first surface; a plurality of first fold lines disposed approximately halfway between the first and second ends; a plurality of second fold lines inward from the second end a distance equal to approximately ten to twenty percent of the length; a first fastener element on the first surface adjacent the first end; and a second fastener element disposed on the second surface adjacent the second end so that when the elongated planar sent is bent along the plurality of first fold lines and the plurality of second fold lines the first and second fasteners can removable attach; a tab extending from the first end, wherein said length is approximately eleven to fourteen inches, and wherein a width of the elongated sheet is approximately four to five inches.

In another aspect of the present invention, a method banding together a plurality of pieces of mail so that end portions of the plurality of pieces of mail are visible, the method includes wrapping the first surface of the file folder of claim 1 until (a) the first surface engages a midsection of the plurality of pieces of mail by way of folding along one fold line of each of the pluralities of first and second fold lines, and (b) the first and second fastener elements form a fastened condition.

These and other features, aspects and advantages of the present invention will become better understood with reference to the following drawings, description, and claims.

### BRIEF DESCRIPTION OF THE DRAWINGS

FIG. 1 is a front elevation view of an exemplary embodiment of the present invention.

FIG. 2 is a rear elevation view of an exemplary embodiment of the present invention.

FIG. 3 is a perspective view of an exemplary embodiment of the present invention, shown in use.

FIG. 4 is a perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a folder assembly having an elongated sheet for binding together documents transversely loaded therein. The elongated sheet may provide two sets of expandable fold lines for folding and wrapping the elongated sheet around the midsection of a stack of documents so that the opposing ends of the documents are visible with the folder assembly fully engaged with the documents. Opposing surfaces of the elongated sheet may provide detachable fasteners for moving the folded elongated sheet to a fastened condition, securely binding or banding the documents. A tab may be provided at one end of the elongated sheet for labeling purposes.

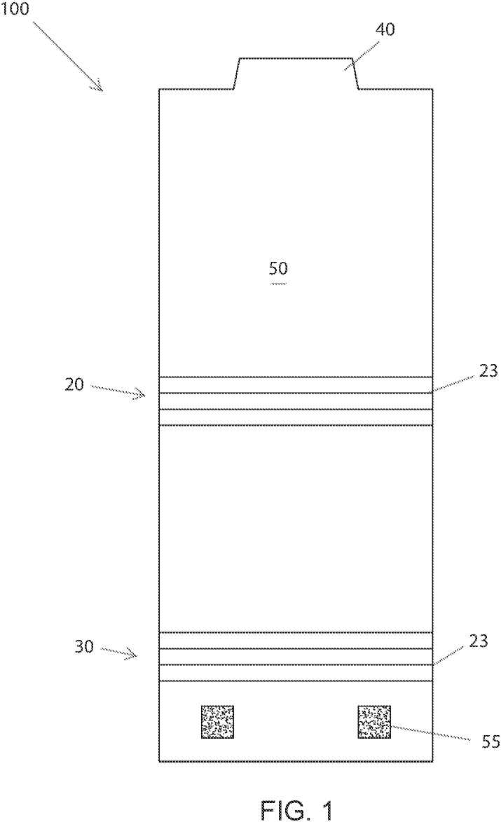

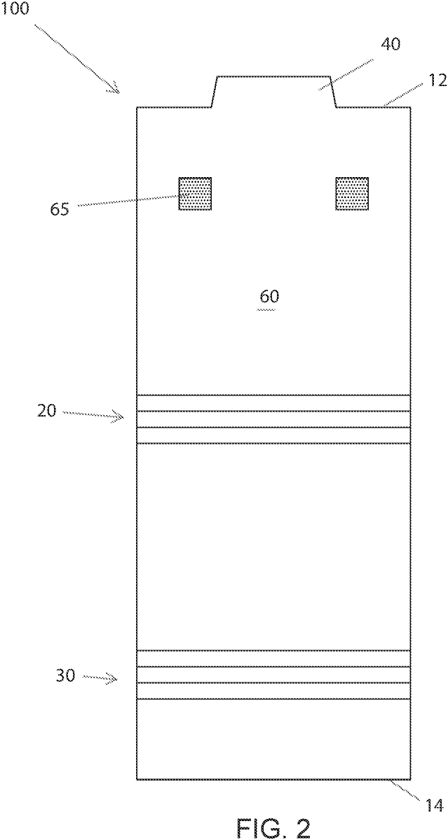

Referring to FIGS. 1 through 4, the present invention may include a folder assembly 100. The folder assembly 100 may provide a planar, elongated sheet 10 of material having a height at least twice that of its width (the height of the elongated sheet 10 is shown extending vertically in FIG. 1). The elongated sheet 10 material may be made of thick, durable manila paper, other types of stiff paper, paperboard, poly-coated paper, or the like, as long as the material is foldable yet sufficiently stiff to provide integrity for the purposes disclosed herein. Typically, the thickness of the sheet 10 material lies in the range 10-100 thousandths of an inch, but the nature and thickness of the material can be selected in accordance with the particular application in hand. Typically, the elongated sheet 10 of material is of uniform thickness. The height of the elongated sheet 10, in different embodiments, range from nine inches to thirty-five inches, while the width of the elongated sheet 10 may range from three inches to six or more inches.

On the elongated sheet 10 may be two sets of fold lines 20 and 30 longitudinally spaced apart. The sets of fold lines 20 and 30 extend widthwise (left to right in FIG. 1). Each set of fold lines 20 and 30 may include a plurality of fold lines 23 equidistantly spaced apart within each set to afford a user selection when determining how and where to fold the elongated sheet 10. Moreover, the plurality of score/fold lines 23 allow each set of fold lines 20 and 30 to be expandable, thereby enabling additional documents 70 to be added to a folded and fastened condition, as discussed more below.

At one end of the elongated sheet 10 may be a tab 40 which extends longitudinally outwardly from the main body of the elongated sheet 10. The tab 40 may be a fraction of the width of the elongated sheet 10 and have tapered shoulders. The tab 40 may be sized to place, print, or mark a label, note, or symbol for tracking purposes.

The thin planar elongated sheet 10 has two major, opposing surfaces 50 and 60 (sometimes referred herein to the ‘front’ or first surface 50 and the ‘rear’ or second surface 60). Along the first surface 50 a first detachable fastener component 55 may be disposed adjacent a lower end 14 (toward the bottom margin of FIG. 1). Along the second surface 60 a second detachable fastener component 65 component may be disposed adjacent an upper end 12 (toward the tab 40). Each detachable fastener component 55 and 65 may include one or more detachable fasteners as long as the two components 55 and 65 have a matching number of fasteners in some embodiments. The detachable fasteners components 55 and 65 are complementary and may be any fastener types that removable attach to each other for form a secure, fastened engagement therebetween, including but not limited to hook and loop fasteners, adhesive strips, flexible wire, and the like.

The first set of fold lines 20 may be about approximately midway between the top end 12 and the bottom end 14 of the elongated sheet 10. Thereby, the first set of fold lines 20 enable a user to fold the elongated sheet 10 in half so that the upper and lower ends 12 and 14 are substantially adjacent. Between these two “halves” a user may add documents 70. The documents 70 may be envelopes, postcards, letters, flats, periodicals, magazines, newspapers, compact discs, and even parcels up to a specified thickness. The document(s) 70 are typically “seated” on or at the first set of fold lines 20.

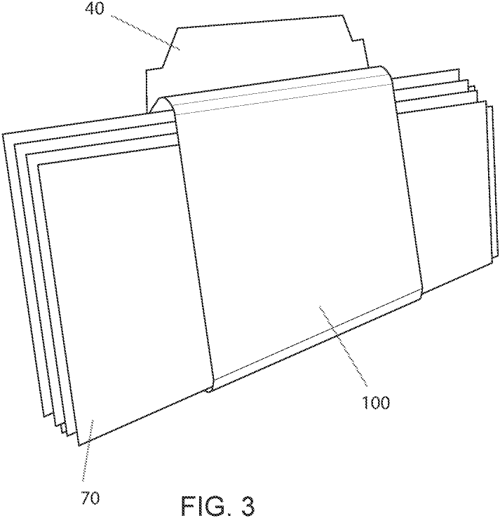

Critically, the length of the document 70 is greater than the width of the elongated sheet 10 so that when the document or documents 70 are banded together by way of the folded elongated sheet, each document projects past both sides of the elongated sheet 10, as shown in FIG. 3. Accordingly, this transverse loading of the documents 70 relative to the elongated sheet 10 affords visibility to a portions of the document 70 so that the user can visually inspect the contents/documents 70 of the folder assembly 100 without manipulating or touching the folder assembly 100.

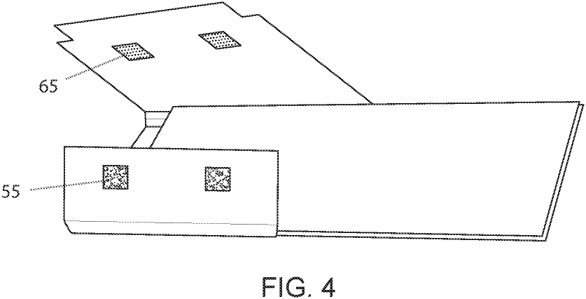

The second set of fold lines 30 are inward of the lower end 14 by ten to twenty percent of the length (upper end 12 to bottom end 14) of the elongated sheet 10. In some embodiments, the second set of fold lines 30 are approximately 1.5 inches from the lower end 14. Folding along at least one fold line 23 of the second set of fold lines 30 enables the user to fold the lower end 14 along the other side of the document(s) 70, as illustrated in FIG. 4. This bottom end 14 can be tucked between the documents and the first surface 60 of the elongated sheet 10 so that the first and second detachable fasteners component 55 and 65 may be fastened together, whereby the first surface wraps completely around the document(s) 70, in a folded and engaged/fastened condition.

In the folded condition, the tab 40 is visible so that labeling or writing thereon can be seen at a glance. Similarly, the opposing ends of the document(s) 70 are visible.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A file folder assembly comprising:
an elongated planar sheet having a length defined by a first end and a second end, the elongated planar sheet having a first surface and a second surface opposing the first surface;
a plurality of first fold lines disposed approximately halfway between the first and second ends;
a plurality of second fold lines inward from the second end a distance equal to approximately ten to twenty percent of the length;
a first fastener element on the first surface adjacent the first end; and
a second fastener element disposed on the second surface adjacent the second end so that when the elongated planar sent is bent along the plurality of first fold lines and the plurality of second fold lines the first and second fasteners can removable attach.

2. The file folder assembly of claim 1, further comprising a tab extending from the first end.

3. The file folder assembly of claim 2, wherein said length is approximately eleven to fourteen inches.

4. The file folder assembly of claim 3, wherein a width of the elongated sheet is approximately four to five inches.

5. A file folder assembly for banding together one or more documents, each document having a document length, the file folder assembly comprising:
an elongated planar sheet having a sheet length defined by a first end and a second end, the elongated planar sheet having a sheet width defined by a first and second edge.
a plurality of first fold lines disposed approximately halfway between the first and second ends;
a plurality of second fold lines inward from the second end a distance equal to approximately ten to twenty percent of the sheet length;
a first fastener element on a first surface adjacent the first end; and
a second fastener element disposed on a second surface adjacent the second end so that when the elongated planar sent is bent along the plurality of first fold lines and the plurality of second fold lines then first and second fasteners form a fastened engagement around a midsection of the one or more documents so that the document length extends beyond both the first and second edges.

6. The file folder assembly of claim 5, further comprising a tab extending from the first end.

7. The file folder assembly of claim 6, wherein said length is approximately eleven to twelve inches.

8. The file folder assembly of claim 7, wherein said width is approximately four to five inches.

9. The file folder assembly of claim 7, wherein the one or more documents are envelopes having a document length of between approximately seven and nine-and-a-half inches.

10. A method banding together a plurality of pieces of mail so that end portions of the plurality of pieces of mail are visible, the method comprising:
wrapping the first surface of the file folder of claim 1 until (a) the first surface engages a midsection of the plurality of pieces of mail by way of folding along one fold line of each of the pluralities of first and second fold lines, and (b) the first and second fastener elements form a fastened condition.
